(19) United States
(12) Patent Application Publication
(10) Pub. No.: US 2017/0070841 A1
(43) Pub. Date: Mar. 9, 2017

(54) APP DISTRIBUTION OVER THE AIR

(71) Applicant: OPEN GARDEN, INC., San Francisco, CA (US)

(72) Inventors: Stanislav Shalunov, Lafayette, CA (US); Gregory Hazel, San Francisco, CA (US); Micha Benoliel, San Francisco, CA (US)

(21) Appl. No.: 14/759,080

(22) PCT Filed: May 14, 2015
(86) PCT No.: PCT/US15/30878

§ 371 Date: Jul. 2, 2015

Related U.S. Application Data
(60) Provisional application No. 62/003,546, filed on May 28, 2014.

(51) Int. Cl. H04W 4/00; H04M 15/00; H04L 29/08

(52) U.S. Cl. CPC H04W 4/001; H04L 67/34; H04W 4/003; H04W 4/008; H04M 15/73; H04W 84/18

(57) ABSTRACT

A method and system for transferring apps between mobile devices without the need to download the app from an app store. Various examples are provided for discovering, authenticating and transmitting the apps among devices directly or via an access point. Even when no connection is available, examples are provided for establishing a mesh network and transferring the app using the mesh network. If not all devices have mesh networking capability, connection such as Bluetooth is used to distribute the mesh network capability and then the mesh network is established.

### RELATED APPLICATIONS

This application claims priority benefit from U.S. Provisional Application Ser. No. 62/003,546, filed on May 28, 2014, the disclosure of which is incorporated herein by reference in its entirety.

### BACKGROUND

1. Field

This disclosure relates to computer Applications, generally referred to as apps, and used on mobile devices, such as smartphones and tablets, and which are normally distributed by having users download them from a central location, referred to as an “app store.”

2. Related Arts

In the prior art, the app store serves as a central repository for apps, which promotes them and enables users to download them. It is a single location on the Internet dedicated for this purpose. For example, consider the case where multiple computers and mobile devices are present in the same home or other location. Using the current standard model, if users wish that a specific app reside on each device, each device must separately, independently download the app initially from the app store. Similarly, each device must download updates for that app from the same central location. However, the application or a current update may already reside on one of the nearby devices. This situation can be optimized.

### SUMMARY

The following summary of the disclosure is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Various disclosed embodiments improve on the standard model for downloading apps, especially in cases of limited or expensive Internet connectivity. Even when broad connectivity is available, the disclosed embodiments help reduce traffic on the network.

According to one example, considering the situation described above, rather than downloading from the central repository, the app can be downloaded instead from a local source which registers the transaction with the central source with the identical security properties as from that central source. In particular, if cryptographic signatures are involved, these same signatures can be obtained from the local source. Such signatures may prove that the distribution is from where is says it's from, for example.

Devices present at a single location may build a (mesh) network among each other to transfer applications, even if a network, e.g., WiFi or cellular network, doesn't already exist. The devices can even transfer among each other the app that builds this mesh network. In one example, OBEX, a protocol for exchanging binary objects among devices that is built into Bluetooth, can be used to transfer .apk and .ipa files containing Android and iOS apps, respectively. It is even possible to distribute paid apps in this way. The security of the payment system in mobile operating systems does not depend on the possession of the bytes. All that must be done is for a device to check with the central authority to verify that the app has been paid for, and only execute the app if payment was verified. Hence, downloading an app and paying for an app can happen at different times. All that is necessary is for the device to verify that the user has paid for the app. If a user has a credit with the app store, payment for an app may not even be necessary. In this case, the cost of the app is simply deducted from the user's balance, which can be stored on the user's device.

Aspects of disclosed embodiments involve a method for obtaining an app to a user device wirelessly from one of a plurality of neighboring mobile devices, comprising: sending from the user device an inquiry for availability of the app; receiving at the user device a response from one of the plurality of neighboring mobile devices, indicating the availability of the app; sending from the user device to the one of the plurality of neighboring mobile devices a request to transmit the app; and, receiving at the user device a transmission of the app from the one of the plurality of neighboring mobile devices. The method may further comprise validating account balance of the user and, if valid, activating the app. Sending the inquiry may comprise broadcasting or multicasting the inquiry. The inquiry may comprise a cryptographic hash value of the app or an app ID. The response may comprise a unicast.

The method may further comprise forming an ad hoc network with the user device and the plurality of mobile devices. Forming an ad hoc network may comprise transmitting a wireless mesh networking application to selected ones of the plurality of neighboring mobile devices that do not have a wireless mesh networking application. The wireless mesh networking application can be transmitted using Bluetooth Object Exchange. The name extension of the networking application can changed prior to transmitting using the Bluetooth Object Exchange. The method may further comprise broadcasting a list of available apps from each of the plurality of neighboring mobile devices. The ID of the app may be obtained from an app store.

According to other aspects, a method is provided for establishing an ad-hoc network among plurality of mobile devices using an enabled device, the method comprises: using Bluetooth connection of the enabling device to discover neighboring mobile devices; determining which of the neighboring devices is non-enabled device; sending an ad hoc networking app from the enabled device to the non-enabled device over the Bluetooth connection; and, using the networking app to establish network connection between the enabled device and the non-enabled device using a WiFi radio. Prior to sending the ad hoc networking app, the method may include determining whether the non-enabling device accepts transmission of the networking app and, if not, changing the name extension of the networking app prior to sending over the Bluetooth connection. After establishing the network connection, the method may further comprise sending from the enabled device a request for a named app and, if the named app resides in the non-enabled device, sending the named app from the non-enabled device to the enabled device.

Further aspects include a method for obtaining an app to a user device wirelessly from a second mobile devices, comprising: sending from the user device to the second mobile device a request to transmit the app; receiving at the user device a transmission of the app from the second mobile device; validating account balance of the user and, if valid, activating the app on the user device, if not, preventing activation of the app on the user device. When the account balance is not valid, the method may further include performing: connecting to an app store via Internet connection and performing an account charge to validate the account balance. Sending the request may be preceded by establishing a mesh network between the user device and the second mobile device, and wherein sending the request and receiving the app are performed over the mesh network. Establishing a mesh network may be preceded by discovering the second mobile device using Bluetooth connection.

Other aspects provide a method for obtaining an app to a user device wirelessly from one of a plurality of mobile devices, comprising: Sending from the user device a request for download of a desired app from an app store; receiving the request at a server and determining whether a neighboring mobile device of the plurality of mobile devices has the desired app already installed; whenever the neighboring mobile device has the app already installed, sending from the server to the user device instructions to obtain the app from the neighboring device; and, when no neighboring device has the app installed, enabling the user device to download the app from the app store. The server may comprise a server hosting the app store or a service server separate from a server hosting the app store. The method may further comprise, when receiving the instructions to obtain the app from a neighboring device, terminating a connection between the user device and the app store. The step of determining may comprise sending an inquiry from a server hosting the app store to a server hosting a service application. The step of sending instructions to obtain the app from the neighboring device may be performed by the service server or the server hosting the app store.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIGS. 1A-1D Illustrate Use Cases according to embodiments of the invention;

FIGS. 2A-2C illustrates how initially unconnected devices detect each other using Bluetooth and send Open Garden software to each other using OBEX, according to embodiments of the invention;

FIGS. 3A and 3B provide an embodiment wherein a user operates device A to obtain the desired app by both visiting the app store over the Internet and obtaining the actual app from another device B directly;

FIGS. 4A and 4B illustrate another embodiment wherein a service server is consulted to obtain neighboring devices.

### DETAILED DESCRIPTION

Various embodiments disclosed herein enable the distribution of apps and updates, without having to connect to the Internet via an access point. This ability is beneficial, for example, when access is unavailable, when access is costly, etc. Additionally, obtaining the app using embodiments of the invention lowers the traffic on the Internet network.

### The Following Use Cases Illustrate Various Embodiments

### Use Case 1.

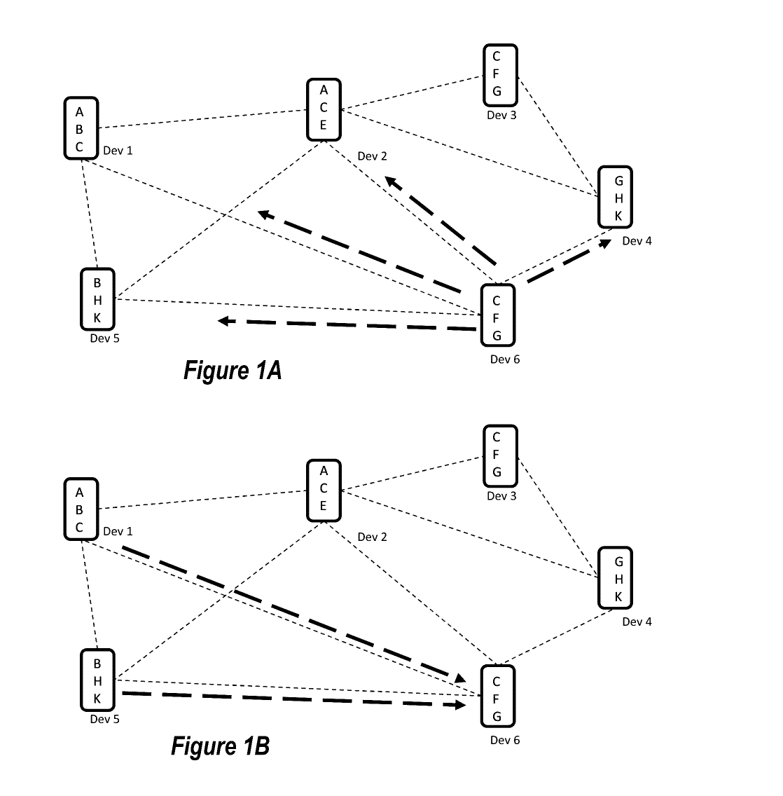

FIGS. 1A-1D illustrate a case wherein Devices 1-6 are connected via a local network (illustrated by broken lines). In this illustrated embodiment, Device 6 saves traffic on downloads from the Internet by getting files directly from another user, i.e., one of Devices 1-5. The user of Device 6 can still communicate with the app store as before, but obtain the bytes of the app itself from a neighboring device 1-5 on the local network. The local network may be, e.g., devices communicating via Bluetooth, devices connected to a common access point via WiFi, devices connected to a common intranet, etc. The main aspect of this embodiment is that Device 6 need not maintain an extended session over an Internet connection with the app store in order to download the app.

In this embodiment, when a user of Device 6 attempts to download an app, first a process is performed to check if the app is available locally (e.g., on any of Devices 1-5). This may be done in several ways. For example, each device in the network may publish a list of apps that reside on it. When Device 6 attempts to obtain an app, it first queries other devices on the local network to see if they have this app. If one does, the app is transferred from that device to Device 6. Then Device 6 checks the account balance at the app store. If the balance is greater than the cost of the app, Device 6 permits it user to use the app immediately. If not, the app initiates a connection to the app store that then generates a request for payment. Once the account has paid, the balance on Device 6 is updated, if necessary, and the app is enabled on Device 6. If the app the user wants does not reside on any device in the local network, only then does Device 6 generate a request to the app store, the central app repository on the Internet, obtaining the app in the traditional manner.

In the example of FIGS. 1A-1D, the various Devices need to locate other devices on their same network and to discover which resources reside on those devices. Devices can use multicast and broadcast messages to achieve this. To use multicast, a fixed “multicast address” is designated in advance and every device that implements this protocol listens to this address. To perform a multicast, a device sends a message to the designated multicast address. Messages sent to that address are forwarded to participating devices. To use multicast optimally, it is first determine whether an app (or any other network resource) is available, then obtain it using the following two phase approach. A device sends a multicast message that says, in effect, “if you (the recipient device of this message) have the app with a given app ID and a given cryptographic hash value, please indicate this by replying to me with a unicast message.” FIG. 1A illustrates an example wherein Device 6 sends a multicast request for App B. Devices having the requested app may transmit a response, indicating that they have the app. For example, FIG. 1B illustrates Devices 1 and 5 sending unicast responses to Device 6 saying “I have App B”. Upon receiving responses from devices which have this app, the device chooses one and sends it a unicast message requesting it to send the app. For example, FIG. 1C illustrates a case where Device 6 chooses Device 5 to send a unicast message saying “Send me App B.” FIG. 1D illustrates and example wherein Device 5 sends App B to Device 6 in a unicast message. In cases where the app or resource is comprised of multiple components, the device can send a unicast requests for each of the component pieces to each of different sources, for efficiency.

The following variations on the optimal protocol are functionally similar, if not exactly equivalent:
Requester uses broadcast instead of multicast. This may require root permission in some operating systems. Broadcast may reach a potentially different set of domains than multicast if either of the routing protocols IGMPv1, IGMPv2 or IGMPv3 is enabled. Broadcast is universally supported by all devices. Some older devices may not support multicast. This may be a consideration for older Ethernet switches.
Responder replies with a multicast that says: “I have it.” This also generates more network traffic. It permits other users on the network to observe both sides of the exchange. On the other hand, those devices may cache the results for possible future use in case they may also want the same app.
Devices send the answer periodically even without having heard the query—essentially broadcasting which resources they have. This is simple to implement but generates more network traffic. It is also robust. Messages may be sent with either broadcast or multicast. Multicast is more modern and permits more refined scoping, but broadcast is more widely available. As noted above, broadcast may require root permission. The same tradeoff exists as described in first point above. However, it is done without having to wait for the query. On the other hand, every device receiving the massages may assemble a catalogue listing devices and their available apps for future use.
Requester sends a generic query that doesn't specify the desired app (effectively saying: “Send me a list of all your apps”); Responders send a generic multicast answer containing a list of all resident apps and resources. This method does not reveal which device requests which app, but does expose which devices have which apps. The Requester receives the responses having lists of all apps and the devices in which they reside and may select one or more of the available apps from one or more Responders. Additionally, every device receiving the massage exchanges may assemble a catalogue listing devices and their available apps for future use.
Requester sends a multicast query that asks: “What apps do you have?” Each recipient sends a unicast response containing a list of IDs for all apps residing on that device. This approach is the same as described in the previous point except responses are unicast instead of multicast.

The common thread running through all these variations is the concept of local discovery. This is the important point, rather than the particular variation used to achieve it. Local discovery obviates the need for sending a request to the app store, which in general may be costlier and slower, as it goes via the Internet. The following are all possible methods for doing this:
One method calls for each device to broadcast its presence, possibly on a periodic basis. Such a broadcast message may include a list of apps that reside on the broadcasting device. This informs all other devices immediately which apps (and other resources) are available, and which devices have them. If a device wants an app, it identifies which devices have sent a list that contains the desired app, and sends a request to any such device to send it the app.
Alternatively, a broadcast message may contain no such list. In this case, a device sends a broadcast message that serves to identify itself and to request other devices to identify themselves by replying (assuming they are on the same network and using the same protocol). If a device wants to obtain an app, it can then broadcast (or multicast just to those devices that responded) a second follow-up message to request the app. Hence, in this scheme, a device sends one multicast message to establish the presence and identity of other devices on the network, and a second message to request the desired app.
A third approach is for a device to send a query that contains a cryptographic signature (or hash) that uniquely identifies the app. This method has the additional benefit that any device receiving the query cannot infer which app the sender is requesting if it does not have the app itself. This is a generic scheme that can apply to any file. A cryptographic signature can be obtained for the entire app file or any other identifying string.

Standard protocols such as Bonjour, mDNS, Wi-Fi Direct, Multipeer Connectivity Framework, and Airdrop may be used by the disclosed embodiments for resource discovery and file transfer. Embodiments disclosed herein offer refinements of resource discovery, which are not present in these protocols, such as the use of a cryptographic hash. Notable contribution of the disclosed invention and embodiments is not resource discovery per se however, but rather resource distribution without the use of a direct connection to an app store, and even without a direct connection to the original source of the app or resource.

In the prior art, mobile devices can get apps only from the app store, using an Internet connection. In this standard method, the operation of getting an app from an app store seems as a single transaction or operation. However, embodiments of the invention break the process of obtaining an app into three distinct operations of 1. getting the actual file of the app, 2. Verifying that the file came from the proper or legitimate source, and 3. Obtaining permission to use the file/app.

In disclosed embodiments, the file is obtained from any mobile device that already has. To reduce traffic over the Internet, various embodiments obtain the file using a local mesh network, i.e., using mobile device to mobile device direct wireless communication. Of course, if both devices are connected to a common access point, the device may make use of that connection to make the transfer via the access point. Once a device obtains the file, it needs to verify that the file in fact originates from an appropriate or legitimate source, e.g., the correct app store. In disclosed embodiments this may be done cryptographically, using a digital signature that can be applied from or verified by either an originating store or from a third-party system. For example, Android requires that all apps be digitally signed with a certificate before they can be installed. Android uses this certificate to identify the author of an app, and the certificate does not need to be signed by a certificate authority. Android apps often use self-signed certificates. The app developer holds the certificate's private key. Thus, other third parties have no convenient way of redistributing that certificate. Therefore, according to disclosed embodiments, a third party server, e.g., Open Garden server, can sign an APK file that it knows to be authentic. In such a case, the clients (phones and tablets) can then verify that signature using the third party server. Once such third party signature operates to verify authenticity of an app, it can be added to the app on the app store, e.g., Google Play, so that it can be used directly to authenticate apps.

In general, all of the embodiments disclosed herein may use encryption to prove authenticity. The following are two examples using cryptographic mechanisms:
Use Public key signatures to provide authenticity. The vendor of the app signs the app and then the app store includes this signature with the app. To ensure the authenticity of apps distributed by the store, the app store can add its own signature to the file. The app is then distributed with the signature of original vendor, the signature of the store, and the certificate of the vendor. The recipient can then obtain the apps from any source since he can verify the signatures from the trusted app store and the app vendor.
Use cryptographic hashes instead of public keys to provide authenticity. In this example each app's ID is made to be its cryptographic hash. Instead of referring to the file by name, we refer to the file by its cryptographic hash value, either or both during requesting an app/file and receiving an app/file. It is easy to check that the file obtained indeed hashes to proper value, and is therefore the desired file.

Finally, once the client has the file and knows it is authentic, it still needs to know that the particular device is allowed to use it—perhaps it is a paid app, or one that's not available in the geographic market, for example. This permission mask can be distributed with the file and applied on client-side.

Use Case 2.

Disconnected local network. In this case, users are on the same Wi-Fi network, but that network is not necessarily connected to the Internet. If a neighboring device (another device on the same network) has the app, then it is possible to download an app from a neighbor as in Use Case 1. If the app is free, the app installs and becomes operational immediately, after confirming the authenticity of the app's origin, which can be provided by cryptographic signatures. The communication between the two mobile devices is done via the common access point locally, without transmission over the Internet. This is similar to file sharing on local network or sending a file to a printer residing on a local network.

If the app is not free, then considerations already covered above come into play. In more detail, consider a user, Joe, who wants to download an app. Joe's device queries the other devices on the network in the manner described in Use Case 1. If the app resides on the device of another user, say, Mary, then Joe's device downloads the app from Mary's, in the manner described above in Use Case 1 through the access point. If Joe's balance at the app store is below the cost of the app, the app will not become operational until the local network next gains Internet access. This verification can be done locally on Joe's device when it maintains an account balance locally. At that point, Joe's device can interact with the app store and generate a request for Joe to make the necessary payment to enable the app.

As above, there can be various refinements. For each of them, the goal is the same: to obtain the app from a local device (local to the wireless network), i.e. without being connected the Internet, and to verify that the app obtained is the app desired. That is, the steps of obtaining and authenticating the files are performed without the need to transmit over the Internet, while the last step of authorizing the app, when required, may be done over the Internet.

Use Case 3. There is no local (Wi-Fi) network, but mobile devices make their own (mesh) network using, for example, Bluetooth, Wi-Fi Direct, Apple's Airdrop or Multi-peer Connectivity Framework, Open Garden, etc. This system works regardless of the underlying method used to create these network connections. In this case, everything works as before, simply using local ad hoc connections instead of Wi-Fi. If a user, George, wants to download an app and his device is not connected to any local wireless network, it first attempts to identify nearby devices using one or more of the above-mentioned mesh networking techniques to scan for nearby devices and create links with those devices it finds. Then, it proceeds as described in the earlier use cases.

In this respect, Open Garden is a free, closed source mobile app that enables peer-to-peer mobile Internet connection sharing with faster and more efficient data transmissions by automatically and actively choosing and switching to the best available network without requiring users to manually sift through available networks to find the best one available. Open Garden enables to efficiently and seamlessly build an ad hoc mesh network among neighboring devices using Bluetooth, WiFi Direct, etc.

Use Case 4:

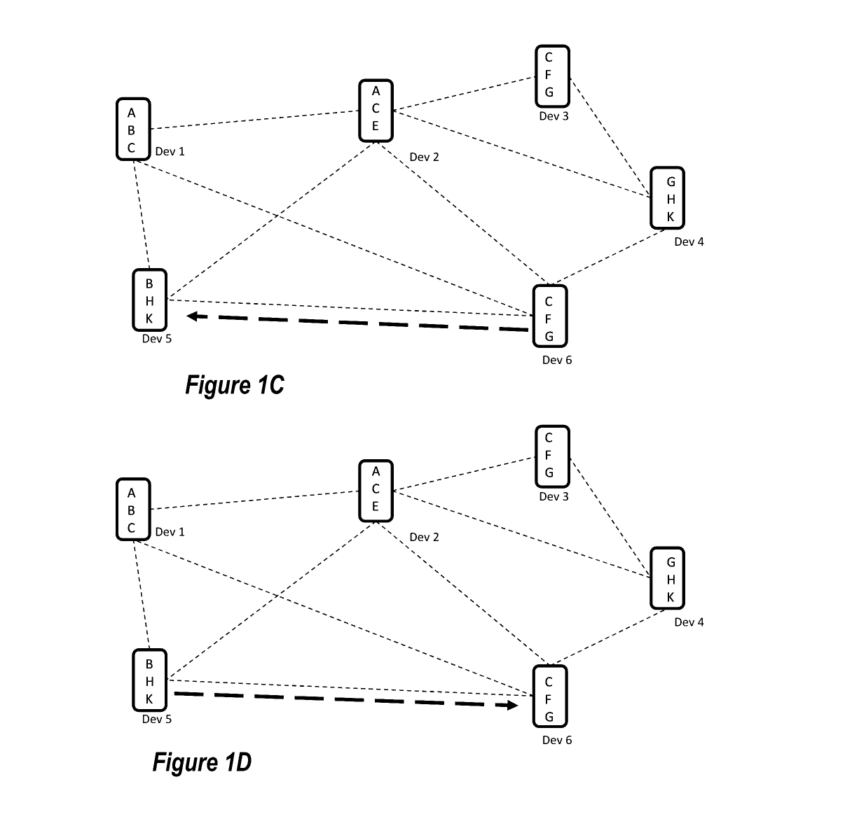

There is no Internet connectivity and no local network. For example, passengers in a flight which does not provide WiFi service will have no Internet connectivity. For this example it is assumed that there is a collection of devices, some of which have the Open Garden app, but some don't. In the context of this disclosure, devices having Open Garden can be referred to as enabled devices, while those that do not have Open Garden can be referred to as non-enabled devices, in that they are not yet enabled to form an ad hoc mesh network. The devices that have Open Garden, i.e., the enabled devices, can form a mesh network, since they have Open Garden software. Devices that don't have it, cannot form or join the mesh network. Open Garden is a wireless mesh networking application that can be used to establish mesh network using the Bluetooth and/or WiFi radio of mobile devices. One cannot obtain Open Garden over Open Garden itself, but we can use Bluetooth Object Exchange (OBEX) to send Open Garden from devices which have Open Garden to those devices that do not yet have Open Garden. Once all the devices have Open Garden, they may form a mesh network on which all devices are connected. An example of links spontaneously forming to create a mesh network in multiple phases is illustrated in FIGS. 2A-2C.

In FIG. 2A, devices 1-5 are unconnected to each other. In the progression from FIG. 2A to FIG. 2C, initially unconnected devices 1-5 detect each other using Bluetooth and send Open Garden software to each other using OBEX (at least one of devices 1-5 should have Open Garden for this process to initiate). After the nodes have Open Garden, they can form a mesh network, and perform local app distribution. In FIG. 2B devices 1 and 2 and devices 3 and 4 establish Bluetooth connection and exchange Open Garden software. In FIG. 2C all of the devices have Open Garden software and all of the devices can use Open Garden to form a mesh network and proceed with app distribution as described in Use Case 4.

Note the following implementation detail: some operating systems may not permit OBEX to send .apk files over the wireless network, including the Open Garden .apk file containing the executable app. It is easy to work around this issue by simply performing the following steps:
Change the file extension of the OpenGarden executable file from .apk to, for example .jpg, because .jpg is always unblocked. Some devices have no restrictions on file names; some devices have restrictions and take the form of a black list, and some have whitelists. In all these examples, it is most likely that .jpg will not be blocked. Therefore, the safest course is to use .jpg (or any other white-listed extension known to not be blocked).
Transfer the file.
Change the extension back to .apk
Install the .apk file.

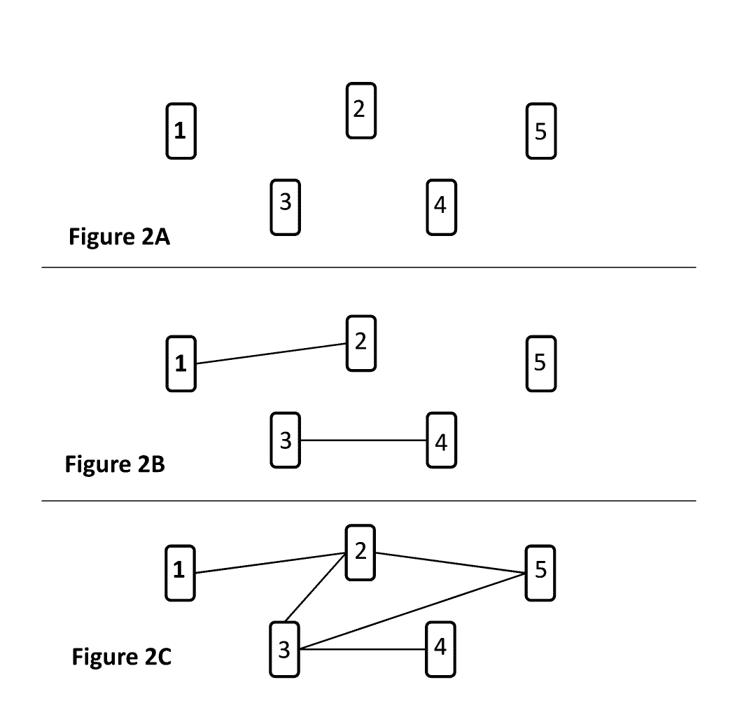

There are, of course, other manners to achieve the objectives of the disclosed invention. FIGS. 3A and 3B provide an embodiment wherein a user operates device A to obtain the desired app by both visiting the app store over the Internet and obtaining the actual app from another device B directly. In step 1, Device A accesses the internet via a standard Internet access point using, e.g., WiFi router, WiMax, 3G, 4G, Edge, LTE, etc. Device A then accesses the app store, e.g., Apple iTunes, Google Play for Android apps, etc. The user may then browse the store to find a desired app. When the user selects an app to download, the app store responds with information regarding a neighboring device B, which already has the desired app installed. The app store may utilize its own database listing which device has downloaded which app to obtain this information. The app store may obtain this information simply from user accounts, or from users' cloud backup, e.g., iCloud for Apple, G Cloud for Android, etc. In optional step 5, Device A may disconnect from the Internet, e.g., to save connection costs, or remain connected if the charge relates to downloaded bytes rather than time. In step 6 Device A obtains the app from device B directly, using any of the methods described above. In this manner, Device A avoids any charges related to connection time of downloaded bytes.

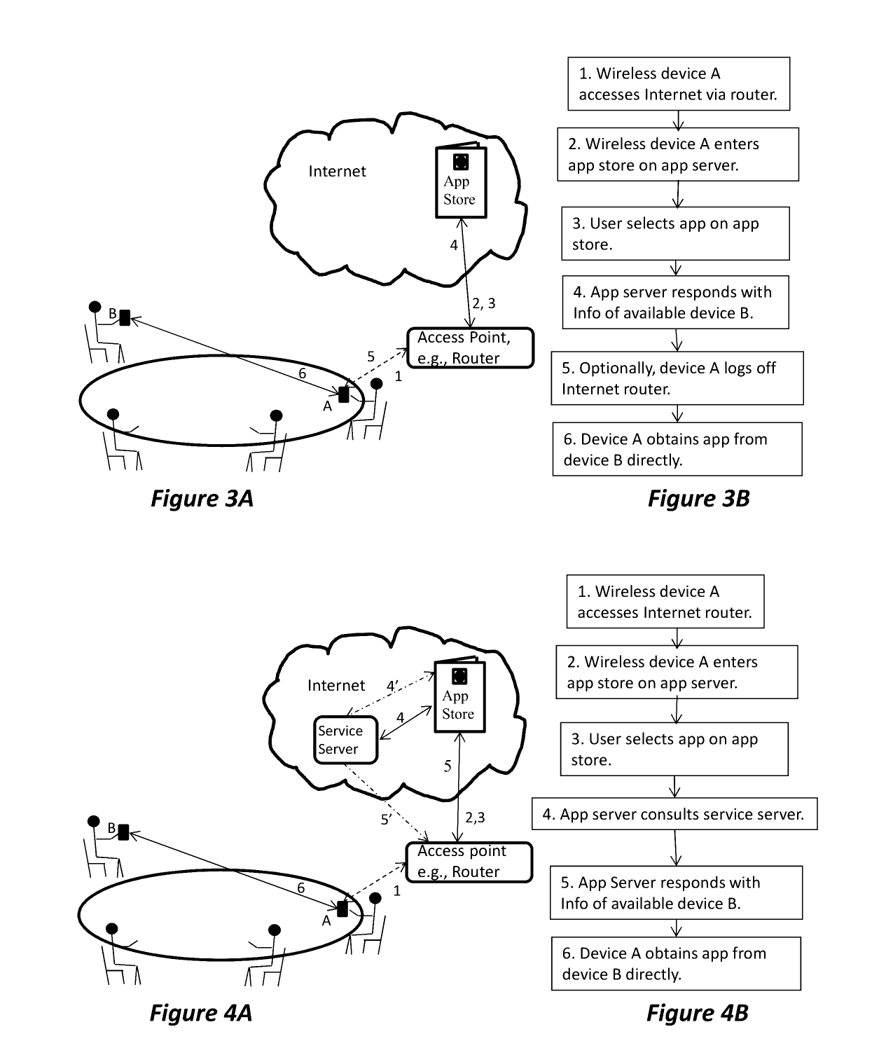

FIGS. 4A and 4B illustrate another embodiment wherein a service server is consulted to obtain neighboring devices. The service server may be, e.g., Open Garden server, which may keep track of devices running Open Garden app and their locations. As in the previous embodiment, here Device A uses WiFi router, WiMax, 3G, 4G, Edge, LTE, etc. Device A then accesses the app store, e.g., Apple iTunes, Google Play for Android apps, etc. The user may then browse the store to find a desired app. When the user selects an app to download, in step 4 the app store sends a request to the service server to check whether there are any neighboring devices having the requested app. If so, in step 5 the app store sends the information regarding the neighboring device, e.g., Device B, to Device A. In step 6 Device A obtains the app from neighboring device B, which already has the desired app installed. In case the service server respond that no neighboring devices are available, the app store may send the app to the Device A directly or ask the user whether he wishes to download the app from the app store.

As shown in FIG. 4A, according to another embodiment, once the user selects a desired app for download from the app store, the app store may simply refer the request to the service server, as illustrated by the dash-dot line marked 4′. The service server checks to see whether a neighboring device has the app installed. This can be accomplished by, for example, interrogating a database of mobile devices that have the service app running Such a service app may be, for example, an Open Garden app, which can be used to form a mesh network and which can report devices' location to the Open Garden service server. All of the reports can be stored and updated in a database of the service server. If the user device runs the Open Garden app, that device will also report its location, so that the service server can determine which devices are neighboring and can be used to transmit the requested app. If the service server determines that a neighboring device has the app, it then sends directions to the user device to obtain the app from the neighboring device, as illustrated by the dash-dot line marked 5′. The directions may include instructions to form a mesh network with the neighboring device, or simply include an identity of the neighboring device, such as, for example, the MAC address of the neighboring device. If the service server does not find a neighboring device having the app, the service server may then return a “not found” message to the app server (illustrated as the double-headed dash-dot line marked 4′), so that the app server can enable download of the app from the app store.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein.

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. It is intended that the specification and examples be considered as exemplary only, with a true scope and spirit of the invention being indicated by the following claims.

1. A method for obtaining an app to a user device wirelessly from one of a plurality of mobile devices, comprising:
sending from the user device an inquiry for availability of the app;
receiving at the user device a response from one of the plurality of mobile devices, indicating the availability of the app;
sending from the user device to the one of the plurality of mobile devices a request to transmit the app;
receiving at the user device a transmission of the app from the one of the plurality of mobile devices; and,
further comprising forming an ad hoc network with the user device and the plurality of mobile devices; and,
wherein forming an ad hoc network comprises transmitting a wireless mesh networking application to selected ones of the plurality of mobile devices that do not have a wireless mesh networking application.

2. The method of claim 1, further comprising validating the authenticity of the app at the user device.

3. The method of claim 2, further comprising validating account balance of the user and, if valid, activating the app

4. The method of claim 1, wherein sending the inquiry comprises broadcasting the inquiry.

5. The method of claim 1, wherein sending the inquiry comprises multicasting the inquiry.

6. The method of claim 1, wherein the inquiry comprises a cryptographic hash value of the app.

7. The method of claim 1, wherein the inquiry comprises an app ID.

8. The method of claim 1, wherein the response comprises a unicast.

9. (canceled)

10. (canceled)

11. The method of claim 1, wherein the wireless mesh networking application is transmitted using Bluetooth Object Exchange.

12. The method of claim 11, wherein the name extension of the networking application is changed prior to transmitting using the Bluetooth Object Exchange.

13. The method of claim 1, further comprising broadcasting a list of available apps from each of the plurality of mobile devices.

14. The method of claim 1, further comprising obtaining an ID of the app from an app store.

15. A Method for establishing an ad-hoc network among plurality of mobile devices using an enabled device, comprising:
using Bluetooth connection of the enabling device to discover neighboring mobile devices;
determining which of the neighboring devices is non-enabled device;
sending an ad hoc networking app from the enabled device to the non-enabled device over the Bluetooth connection;
using the networking app to establish network connection between the enabled device and the non-enabled device using a WiFi radio.

16. The method of claim 15, wherein prior to sending the ad hoc networking app, determining whether the non-enabling device accepts transmission of the networking app and, if not, changing the name extension of the networking app prior to sending over the Bluetooth connection.

17. The method of claim 15, wherein after establishing the network connection, further comprising sending from the enabled device a request for a named app and, if the named app resides in the non-enabled device, sending the named app from the non-enabled device to the enabled device.

18. A method for obtaining an app to a user device wirelessly from a second mobile devices, comprising:
sending from the user device to the second mobile device a request to transmit the app;
receiving at the user device a transmission of the app from the second mobile device;
validating account balance of the user and, if valid, activating the app on the user device, if not, preventing activation of the app on the user device.

19. The method of claim 18, wherein when the account balance is not valid, further performing:
connecting to an app store via Internet connection and performing an account charge to validate the account balance.

20. The method of claim 18, wherein sending the request is preceded by establishing a mesh network between the user device and the second mobile device, and wherein sending the request and receiving the app are performed over the mesh network.

21. The method of claim 20, wherein establishing a mesh network is preceded by discovering the second mobile device using Bluetooth connection.

22. A method for obtaining an app to a user device wirelessly from one of a plurality of mobile devices, comprising:
Sending from the user device a request for download of a desired app from an app store;
receiving the request at a server, and determining whether a neighboring mobile device of the plurality of mobile devices has the desired app already installed;
whenever the neighboring mobile device has the app already installed, sending from the server to the user device instructions to obtain the app from the neighboring device; and,
when no neighboring device has the app installed, enabling the user device to download the app from the app store.

23. The method of claim 22, wherein the server comprises a server hosting the app store.

24. The method of claim 22, wherein the server comprises a service server separate from a server hosting the app store.

25. The method of claim 22, further comprising, when receiving the instructions to obtain the app from a neighboring device, terminating a connection between the user device and the app store.

26. The method of claim 22 wherein the step of determining comprises sending an inquiry from a server hosting the app store to a server hosting a service application.

27. The method of claim 26, wherein the step of sending instructions to obtain the app from the neighboring device is performed by the service server.

28. The method of claim 26, wherein the step of sending instructions to obtain the app from the neighboring device is performed by the server hosting the app store.
